(19) United States
(12) Patent Application Publication
(10) Pub. No.: US 2009/0115579 A1
(43) Pub. Date: May 7, 2009

(54) SIGNAL PROCESSING APPARATUS FOR RECEIVING RFID SIGNAL AND METHOD THEREOF

(75) Inventors: MING TSAI CHEN, HSINCHU (TW); MING TSANG CHEN, HSINCHU (TW); YUNG KANG CHEN, HSINCHU (TW); YAO CHENG YEH, HSINCHU (TW); YI FENG SU, HSINCHU (TW)

Correspondence Address: WPAT, PC;INTELLECTUAL PROPERTY ATTORNEYS, 2030 MAIN STREET, SUITE 1300, IRVINE, CA, 92614, US

(73) Assignee: MICROELECTRONICS TECHNOLOGY INC., HSINCHU (TW)

(21) Appl. No.: 12/245,925

(22) Filed: Oct. 6, 2008

(30) Foreign Application Priority Data
Nov. 6, 2007 (TW) 096141799

(51) Int. Cl. H04Q 5/22

(52) U.S. Cl. 340/10.1

(57) ABSTRACT

A signal processing apparatus for receiving RFID signal comprises a first low-pass filter, a first down-sampler, a first comparator and a first waveform converter. The first low-pass filter filters the RFID signal. The first down-sampler down-samples the filtered RFID signal. The first comparator generates a new signal for value determination according to the down-sampled RFID signal. The first waveform converter converts the waveform of the new signal for the following process.

### BACKGROUND OF THE INVENTION

(A) Field of the Invention

The present invention relates to a method and apparatus for receiving radio-frequency identification (RFID) signals, and more particularly, to a method and apparatus for identifying RFID signals via signal processing techniques.

(B) Description of the Related Art

Radio-frequency identification (RFID) is an automatic identification method, relying on storage and remote retrieval of data using devices called RFID tags or transponders. Typically, an RFID system is composed of an RFID tag and an RFID identification apparatus. The RFID tag emits an identification signal automatically or generates it when receiving a signal from the RFID identification apparatus. The RFID identification apparatus receives the identification signal to identify the RFID tag. Because of the convenience of RFID technique, it is mainly applied to enterprise supply chain management, such as product tracking and inventory management, while tranportation payments, passport, vehicle management, animal tags, human implants and library management are all fields to which RFID technique may apply.

Traditionally, an RFID identification apparatus determines the values of received RFID signals by a low-pass filter and a comparator. However, the decision made by the comparator is only based on a threshold, while the waveform and magnitude of RFID signals may be distorted because of various influences. For example, high temperature may cause the rising time of RFID signals to be extended, and noise may exist when an RFID tag is in a long-distance signal or in an environment that is too complex. In addition, there may be a biased voltage when an RFID signal exhibits a high bit rate. Any of the interferences mentioned above may cause the identification rate of an RFID system to drop. In current Electronic Product Code (EPC) regulation, the bit rates of RFID systems include 40 kbps, 80 kbps, 160 kbps, 320 kbps and 640 kbps. However, the RFID identification apparatus mentioned above may only operate under 80 kbps. Therefore, there is a need to design an apparatus and a method to improve the identification rate and bit rate of RFID systems.

### SUMMARY OF THE INVENTION

The main objective of the present invention is to enhance the identification rate of RFID systems by identifying RFID signals via signal processing techniques.

The first embodiment of the present invention is a signal processing apparatus for receiving RFID signal comprising a first low-pass filter, a first down-sampler, a first comparator and a first waveform converter. The first low-pass filter removes the high frequency component from the RFID signal. The first down-sampler down-samples the filtered RFID signal. The first comparator generates a new signal for value determination according to the down-sampled RFID signal. The first waveform converter reforms the waveform of the new signal.

The second embodiment of the present invention is an apparatus for receiving RFID signal comprising an analog-to-digital converter (ADC), a signal processing apparatus of the first embodiment and a microprocessor. The ADC receives an analog RFID signal and converts it to a digital RFID signal. The signal processing apparatus is connected to the ADC. The microprocessor is connected to the signal processing apparatus.

The third embodiment of the present invention is a method for receiving RFID signal comprising the steps of: receiving RFID signals; low-passing the received RFID signals; down-sampling the filtered RFID signals; comparing the down-sampled RFID signals to an ideal signal to generate signals for value determination; and converting the signals for value determination into square wave signals based on their value.

### BRIEF DESCRIPTION OF THE DRAWINGS

The objectives and advantages of the present invention will become apparent upon reading the following description and upon reference to the accompanying drawings in which:

FIG. 1 shows an apparatus for receiving RFID signal of the first embodiment of the present invention;

FIG. 2 shows a signal processing apparatus for receiving RFID signal of the second embodiment of the present invention; and

FIG. 3 shows the flow chart of a signal processing method for receiving RFID signal of the third embodiment of the present invention.

### DETAILED DESCRIPTION OF THE INVENTION

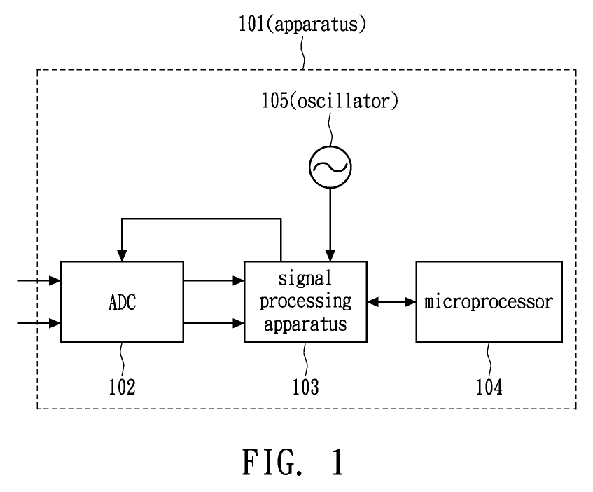

FIG. 1 shows an apparatus for receiving RFID signal of the first embodiment of the present invention. The signal processing apparatus 101 comprises an ADC 102, a signal processing apparatus 103, a microprocessor 104 and an oscillator 105. The ADC 102 receives two analog RFID signals with 90 degrees of phase difference and converts them into two digital RFID signals with 90 degrees of phase difference. The signal processing apparatus 103 executes calculation of high clock rate. It filters and compares the two digital RFID signals to generate a square wave signal for the microprocessor 104. The microprocessor 104 executes low clock rate and high-level calculations. The oscillator 105 generates a clock signal with high clock rate for the ADC 10 and the signal processing apparatus 103.

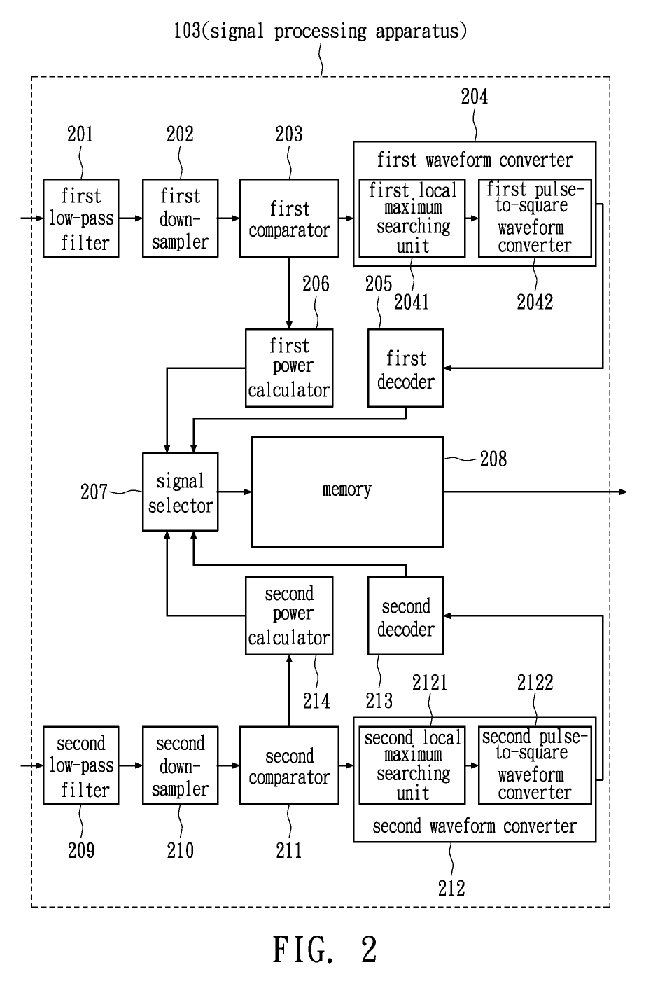

FIG. 2 shows a signal processing apparatus for receiving RFID signal of the second embodiment of the present invention. The signal processing apparatus 103 is implemented on a field programmable gate array (FPGA) and comprises a first low-pass filter 201, a first down-sampler 202, a first comparator 203, a first waveform converter 204, a first decoder 205, a first power calculator 206, a signal selector 207, a memory 208, a second low-pass filter 209, a second down-sampler 210, a second comparator 211, a second waveform converter 212, a second decoder 213 and a second power calculator 214. The first low-pass filter 201, the first down-sampler 202, the first comparator 203, the first waveform converter 204, the first decoder 205 and the first power calculator 206 are for the signal processing of a first RFID signal. The second low-pass filter 209, the second down-sampler 210, the second comparator 211, the second waveform converter 212, the second decoder 213 and the second power calculator 214 are for the signal processing of a second RFID signal of a phase difference from the first RFID signal. The two groups of circuits exhibit the same function, but process different signals.

The first low-pass filter 201 and the second low-pass filter 209 are operated in a moving average manner to filter out the high frequency component from the RFID signals. The first down-sampler 202 and the second down-sampler 210 down-sample the filtered RFID signals with different sampling rates into RFID signals with the same sampling rate. For example, if an RFID signal with bit rate 40 kbps is sampled with sampling rate 20.48 MHz, then there will be 512 sampling points in one symbol. If an RFID signal with bit rate 640 kbps is sampled with the same sampling rate, then there will be 32 sampling points in one symbol. Therefore the first down-sampler 202 and the second down-sampler 210 are needed. Therefore, RFID signals with bit rate 40 kbps are down-sampled with rate 1/16, RFID signals with bit rate 80 kbps are down-sampled with rate ⅛, RFID signals with bit rate 640 kbps are not down-sampled, and the rest may be deduced by analogy. The first comparator 203 and the second comparator 211, both match filters, compare the down-sampled RFID signals with an ideal signal to generate a first and a second post-comparing signal. The first waveform converter 204 comprises a first local maximum searching unit 2041 and a first pulse-to-square waveform converter 2042. The second waveform converter 212 comprises a second local maximum searching unit 2121 and a second pulse-to-square waveform converter 2122. The first local maximum searching unit 2041 and the second local maximum searching unit 2121 search for maximum values among every sampling point of the symbols to determine whether the values of the symbols are high or low. The first pulse-to-square waveform converter 2042 and the second pulse-to-square waveform converter 2122 convert the pulse signals into square waveform signals based on maximum values found. The first decoder 205 and the second decoder 213, dealing with decoding high clock rate process to alleviate the burden of the microprocessor 104 in FIG. 1, decode the output signals from the first waveform converter 204 and the second waveform converter 212 respectively according to the standards of EPC. The first power calculator 206 and the second power calculator 214 calculate the power of the output RFID signals of the first comparator 203 and the second comparator 211 respectively. The signal selector 207 selects the RFID signal with higher power among the output signals of the first power calculator 206 and the second power calculator 214. Optionally, the first power calculator 206 and the second power calculator 214 can be combined into a single power calculator, while the power of the RFID signals are calculated in time-division manner. The memory 208 stores the result of the signal processing apparatus 103 for the following circuit, such as the microprocessor 104.

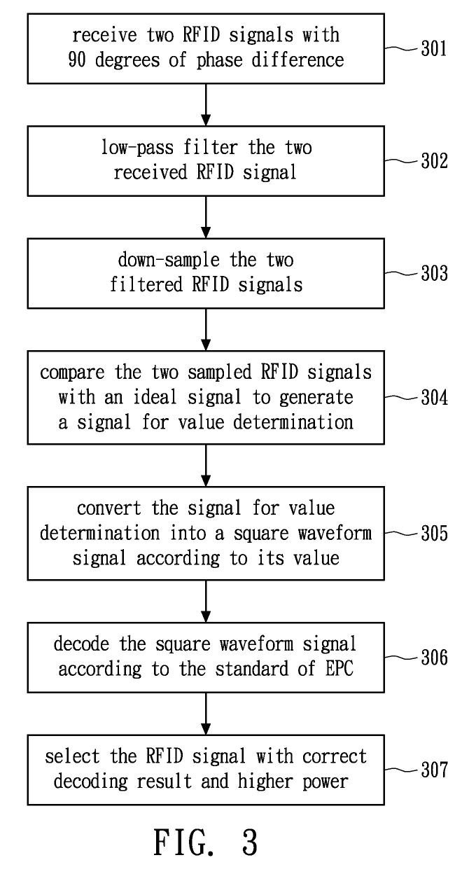

FIG. 3 shows the flow chart of a signal processing method for receiving RFID signal of the third embodiment of the present invention. At step 301, two RFID signals are received with 90 degrees of phase difference. At step 302, the two received RFID signals are low-pass filtered. At step 303, the two filtered RFID signals are down-sampled. At step 304, the two sampled RFID signals are compared with an ideal signal to generate a signal for value determination. At step 305, the signal is converted for value determination into a square waveform signal according to its value. At step 306, the square waveform signal is decoded according to the EPC standard. At step 307, the RFID signal with correct decoding result and higher power is selected.

Compared to traditional RFID apparatus, the signal processing apparatus for receiving RFID signal of the present invention enhances its signal receiving distance from 3-4 meters to 8 meters, and the bit rates of received RFID signals are increased from 640 kbps to 800 kbps. Therefore, with the same identification rate, the signal processing apparatus for receiving RFID signal of the present invention can exhibit significantly improved signal receiving distance and bit rate.

The above-described embodiments of the present invention are intended to be illustrative only. Those skilled in the art may devise numerous alternative embodiments without departing from the scope of the following claims.

What is claimed is:

1. A signal processing apparatus for receiving radio-frequency identification (RFID) signal, comprising:
a first low-pass filter configured to filter out high frequency component from a first RFID signal;
a first down-sampler configured to down-sample the filtered first RFID signal;
a first comparator configured to generate a first post-comparing signal for value determination according to the down-sampled first RFID signal; and
a first waveform converter configured to reform the waveform of the first post-comparing signal.

2. The signal processing apparatus of claim 1, further comprising:
a second low-pass filter configured to filter out high frequency component from a second RFID signal with 90 degrees of phase difference from the first RFID signal;
a second down-sampler configured to down-sample the filtered second RFID signal;
a second comparator configured to generate a second post-comparing signal for value determination according to the down-sampled second RFID signal; and
a second waveform converter configured to reform the waveform of the second post-comparing signal.

3. The signal processing apparatus of claim 2, further comprising:
a first power calculator configured to calculate the power of the first RFID signal;
a second power calculator configured to calculate the power of the second RFID signal; and
a signal selector configured to select an RFID signal with higher power according to the first power calculator and the second power calculator.

4. The signal processing apparatus of claim 2, further comprising:
a power calculator configured to calculate the power of the first RFID signal and the second RFID signal;
a signal selector configured to select an RFID signal with higher power according to the power calculator.

5. The signal processing apparatus of claim 1, further comprising a first decoder configured to decode the output signal of the first waveform converter according to the standard of Electronic Product Code (EPC).

6. The signal processing apparatus of claim 2, further comprising a second decoder configured to decode the output signal of the second waveform converter according to the standard of EPC.

7. The signal processing apparatus of claim 1, further comprising a memory configured to store the output of the signal processing apparatus.

8. The signal processing apparatus of claim 1, wherein the first low-pass filter is configured to operate in a moving average manner.

9. The signal processing apparatus of claim 2, wherein the second low-pass filter is configured to operate in a moving average manner.

10. The signal processing apparatus of claim 1, wherein the first comparator is a match filter and compares the down-sampled first RFID signal with an ideal signal to generate the first post-comparing signal.

11. The signal processing apparatus of claim 2, wherein the second comparator is a match filter and compares the down-sampled second RFID signal with an ideal signal to generate the second post-comparing signal.

12. The signal processing apparatus of claim 1, wherein the first waveform converter comprises:
a first local maximum search unit configured to search maximum value of the first post-comparing signal; and
a first pulse-to-square waveform converter configured to convert the first post-comparing signal into a square waveform signal according to the maximum value calculated by the first local maximum search unit.

13. The signal processing apparatus of claim 2, wherein the second waveform converter comprises:
a second local maximum search unit configured to search maximum value of the second post-comparing signal; and
a second pulse-to-square waveform converter configured to convert the second post-comparing signal into a square waveform signal according to the maximum value calculated by the second local maximum search unit.

14. The signal processing apparatus of claim 1, wherein the first down-sampler is configured to down-sample RFID signals with different sampling rates into RFID signals with the same sampling rate.

15. The signal processing apparatus of claim 2, wherein the second down-sampler is configured to down-sample RFID signals with different sampling rates into RFID signals with the same sampling rate.

16. The signal processing apparatus of claim 14, wherein the different sampling rates include 40 kbps, 80 kbps, 160 kbps, 320 kbps and 640 kbps.

17. The signal processing apparatus of claim 1, which is implemented on a field programmable gate array (FPGA).

18. A apparatus for receiving radio-frequency identification (RFID) signal, comprising:
an analog-to-digital converter configured to convert received analog RFID signals into digital RFID signals;
a signal processing apparatus of claim 1 configured to execute the signal processing of the digital RFID signals; and
a microprocessor coupled to the signal processing apparatus.

19. The apparatus of claim 18, wherein the analog-to-digital converter is configured to convert two analog RFID signals with 90 degrees of phase difference into two digital RFID signals with 90 degrees of phase difference.

20. The apparatus of claim 18, further comprising an oscillator configured to generate a clock signal for the analog-to-digital converter and the signal processing apparatus.

21. The apparatus of claim 18, wherein the signal processing apparatus is implemented on an FPGA.

22. A method for receiving RFID signal, comprising steps of:
receiving RFID signals;
low-passing the received RFID signals;
down-sampling the filtered RFID signals;
comparing the down-sampled RFID signals to an ideal signal to generate signals for value determination; and
converting the signals for value determination into square waveform signals based on their value.

23. The method for receiving RFID signal of claim 22, wherein the RFID signals exhibit a phase difference of 90 degrees.

24. The method for receiving RFID signal of claim 22, further comprising a step of decoding the square waveform signals according to the standard of EPC.

25. The method for receiving RFID signal of claim 24, further comprising a step of selecting the RFID signal with correct decoding result and higher power.
